(19) United States
(12) Patent Application Publication
(10) Pub. No.: US 2020/0149559 A1
(43) Pub. Date: May 14, 2020

(54) EXTENDED HYDRAULIC ACCUMULATOR PISTON

(71) Applicant: Andritz Inc., Alpharetta, GA (US)

(72) Inventors: Grant Bechard, Glens Falls, NY (US); Jonathan Steinbiss, Glens Falls, NY (US); Brandon Smith, Pell City, AL (US)

(21) Appl. No.: 16/665,537

(22) Filed: Oct. 28, 2019

Related U.S. Application Data
(60) Provisional application No. 62/758,056, filed on Nov. 9, 2018.

(51) Int. Cl. F15B 1/02

(52) U.S. Cl. CPC F15B 1/02; F15B 2201/40

(57) ABSTRACT

A method of hydraulic actuation that includes positioning a piston within the chamber of a cylinder body, the chamber including a gas region and a fluidized region, the sidewall of the piston including at least one sealing surface for engaging the sidewall of chamber; and traversing the piston between a portion of the gas region and a portion of the fluidized region, wherein a distance of travel within the chamber that the piston traverses between the gas region and the fluidized region is less than a length of the sidewall of the piston. By increasing the length of the piston sidewall and decreasing the distance of travel for the piston, the method eliminates or substantially reduces fluid carry over in accumulators.

### CROSS-RELATED APPLICATION

This application claims the benefit under 35 U.S.C. § 119 (e) of the earlier filing date of U.S. Provisional Patent Application No. 62/758,056 filed on Nov. 9, 2018, the entirety of which is incorporated herein by reference.

### TECHNICAL FIELD

The present disclosure generally relates to accumulators and more particularly to piston (also known as “float”) arrangements in hydraulic accumulators.

### RELATED ART

A hydraulic accumulator is a device in which potential energy is stored in the form of a compressed gas used to exert a force against a relatively incompressible fluid. A hydraulic system utilizing an accumulator can use a smaller fluid pump, since the accumulator stores energy from the pump during low demand periods. This energy is available for instantaneous use, released upon demand at a rate many times greater than could be supplied by the pump alone.

Hydro-pneumatic accumulators incorporate a gas in conjunction with a hydraulic fluid. The fluid has little dynamic power storage qualities. The fluid normally used in fluid power applications can be reduced in volume only about 1.7% under a pressure of 5000 PSI. Therefore, when only 2% of the total contained volume is released, the pressure of the remaining oil in the system will drop to zero. However, the relative incompressibility of a hydraulic fluid makes it ideal for fluid power systems and provides quick response to power demand.

The gas in a hydro-pneumatic accumulator is a partner to the hydraulic fluid and can be compressed to high pressures and low volumes. Potential energy is stored in this compressed gas to be released upon demand. In the piston type accumulator, the energy in the compressed gas exerts pressure against the piston separating the gas and hydraulic fluid. The piston in turn forces the fluid from the cylinder into the system and to the location where useful work will be accomplished.

### SUMMARY

In one aspect, a method of operating an accumulator is provided that substantially reduces or eliminates the incidence of fluid carry over. Fluid carry over occurs when fluid from the hydraulic actuated side of the accumulator leaks past the seals of the piston to the gas side of the accumulator. The gas can be nitrogen, for example. Fluid carry over may also be referred to as oil carry over, when the fluid being carried over is an oil based fluid.

In one embodiment, a method of hydraulic actuation is provided that includes positioning a piston within the chamber of a cylinder body, the chamber can include a gas region and a fluidized region, the sidewall of the piston can include at least one sealing surface for engaging the sidewall of chamber. The method can further include traversing the piston between a portion of the gas region and a portion of the fluidized region, wherein a distance of travel within the chamber that traverses the piston between the gas region and the fluidized region is less than a length of the sidewall of the piston.

In another aspect of the present disclosure, an accumulator is provided in which the piston travel is configured to reduce fluid carry over. In one embodiment, an accumulator is provided that includes a cylinder body having a chamber including a gas region and a fluidized region. A piston is present within the chamber of the cylinder body. The deck surface of the piston faces the gas region of the chamber, and the skirt end of the piston faces the fluidized region of the chamber. The sidewall of the piston includes at least one sealing surface for engaging the sidewall of chamber. The length of the sidewall of the piston is dimensioned so that a distance of travel within the chamber that traverses the piston between the gas region and the fluidized region is less than the length of the sidewall of the piston.

In yet another aspect of the present disclosure, a piston (also referred to as float) is provided to reduce fluid carry over in accumulators. The piston may be referred to as an extended float. The piston includes a deck surface that provides an interface between the gas region and the fluidized region of the chamber of the accumulator. The piston includes a skirt sidewall that extends from the deck surface. The skirt sidewall includes at least one sealing surface for engaging a sidewall of chamber including the gas region and the fluidized region for the accumulator. The skirt sidewall having a length that is at least equal to the width of the deck surface. In some embodiments, by increasing the length of the skirt sidewall to be greater than or equal to the width of the deck surface, the travel distance of the piston within the chamber between the fluidized region and the gas region may be reduced. For example, the travel distance for the piston may be less than the length of the skirt sidewall. This reduces the wear on the at least one sealing surface, and therefore can increase the resistance of the accumulator including the piston to fluid carry over.

These and other features and advantages will become apparent from the following detailed description of illustrative embodiments thereof, which is to be read in connection with the accompanying drawings.

### BRIEF DESCRIPTION OF THE DRAWINGS

The following description will provide details of embodiments with reference to the following figures wherein:

FIG. 1 is a side cross-sectional view of an accumulator including a piston design for substantially reducing, if not eliminating, fluid carry over, in accordance with one embodiment of the present disclosure.

FIG. 2 is a top down view of the accumulator that is depicted in FIG. 1.

FIG. 3 is a bottom up view of the accumulator that is depicted in FIG. 1.

FIG. 4 is a perspective of a piston design for being employed in an accumulator to reduce, if not eliminate, fluid carry over, in accordance with one embodiment of the present disclosure.

FIG. 5 is a side view of the piston design depicted in FIG. 4.

FIG. 6 is a side cross-sectional view along section line A-A of the piston design depicted in FIG. 5.

### DETAILED DESCRIPTION

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

A hydraulic accumulator is a device that stores oil under pressure and utilizes compressed nitrogen (compressed gas) to deliver high flow oil (hydraulic fluid). A float (hereafter referred to as a piston) is used to separate the oil from the nitrogen within the accumulator. As oil enters the bottom of the accumulator, the piston is moved and the piston compresses the nitrogen gas (above the float) until the oil and the nitrogen are both at system operating pressure. The oil is stored at pressure and is available when the system requires the oil.

In a hydraulic system that requires a cylinder to move quickly, an accumulator is used to supply the high flow oil, at operating pressure. The accumulator oil flow rate is much greater than the hydraulic pump within the system, and can perform the task when the pump cannot, because of capacity limitations. During the delivery of the high flow oil from the accumulator, the float “travels” a certain distance within the accumulator. Once the needed volume of oil is delivered, the float stops, and the accumulator is ready to receive more oil for the next needed volume. This “cycle” happens thousands of times a day when in operation.

A recurring issue with accumulators is “fluid carry over.” This term refers to hydraulic fluid that gets on the nitrogen side, i.e., gas side, of the accumulator. This carry-over fluid compresses the nitrogen, but the carry-over liquid is of no use to the system because the carry-over liquid is on the gas side of the piston, and thus limits the usable oil on the fluid side of the piston. The seals on the piston sidewalls “wipe” the fluid off the barrel of the accumulator with each cycle. As the seals wear, the wiping effect lessens and the film of fluid on the barrel has the opportunity to enter the nitrogen side of the accumulator with each cycle, which happens thousands of times a day. When the carry-over fluid accumulates to the point where the “usable” fluid on the fluid side of the piston is not sufficient to keep the system operating, the system must be shut down and the carry-over oil must be drained out of the accumulator. This disruption in system operation causes issues for the mill, unwanted downtime, and loss of overall mill production.

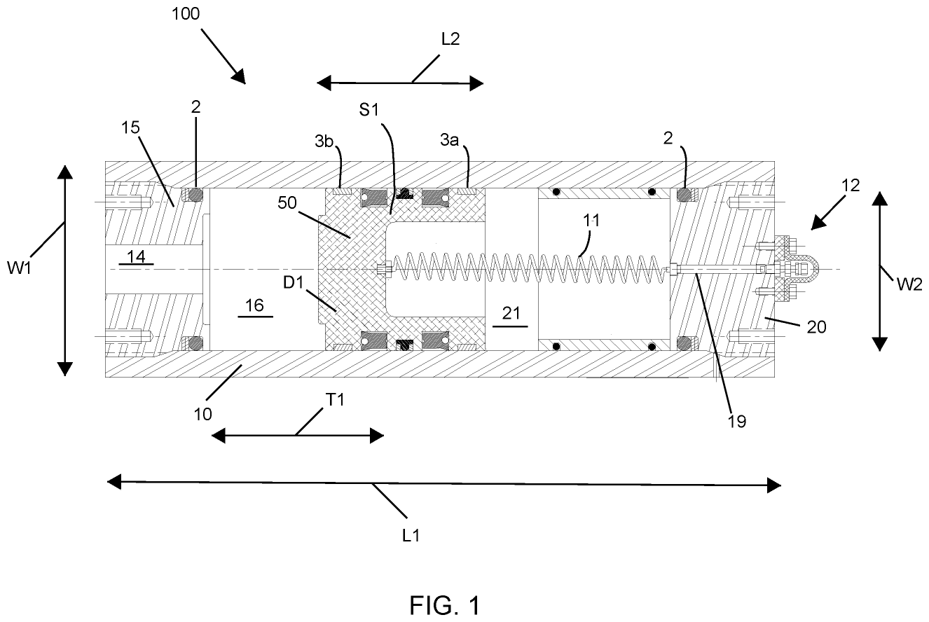

In the methods and structures that are described herein, a piston (also referred to as a float) is provided for use in accumulators, in which the length of the sidewall of the piston, e.g., length of piston skirt, is sized for volumetric delivery. For example, the height, e.g., length of the piston skirt, of the piston (float) will be at a length that is just greater than the calculated “travel” of the piston (float) within the accumulator. This increase in the sidewall length of the piston, which is an increase in the length of the piston skirt, can be referred to as an “extended float”. By extending the float to this length the wall “fluid film” will have limited exposure to the nitrogen side of the accumulator, thus reducing “fluid carry over.” It is contemplated that this calculated approach can reduce fluid carry over, reduce maintenance hours, and reduce operational downtime. The methods and structures of the present disclosure are now described in greater detail with reference to FIGS. 1-6.

FIGS. 1-3 depict an accumulator 100 including a piston 50 design for substantially reducing, if not eliminating, fluid carry over. The accumulator 100 is shown including a housing 10 that can be in the form of a cylinder that includes a fluid head 15 at one end and a gas head 20 at a second end. In some embodiments, the housing 10 of the accumulator 100 can be composed of a metal, such as steel or aluminum. In one example, the housing 10 of the accumulator 100 can be composed of carbon steel. The accumulator 100. e.g., housing 10 of the accumulator 100, can have a length L1 ranging from 8 ft. to 12 ft. In one example, the length L1 of the accumulator 100 is equal to 117″ (9.75 ft.) The accumulator 100. e.g., housing 10 of the accumulator 100, can have a width W1 ranging from 6″ to 18″. In one example, the width W1 of the housing 10 of the accumulator 100 can be equal to approximately 14″. In one example, the accumulator 100 having a length dimensions L1 equal to 117″ (9.75 ft.) and a width W1 equal to approximately 14″ may have a capacity on the order of 50 gallons. It is noted that the dimensions for the accumulator housing 10 are provided for illustrative purposes only, and are not intended to limit the present disclosure, as other dimensions are equally applicable, so long as the dimensions for the accumulator chamber and piston 50 that is disposed therein can reduce or eliminate the incidence of carry over oil as further described herein.

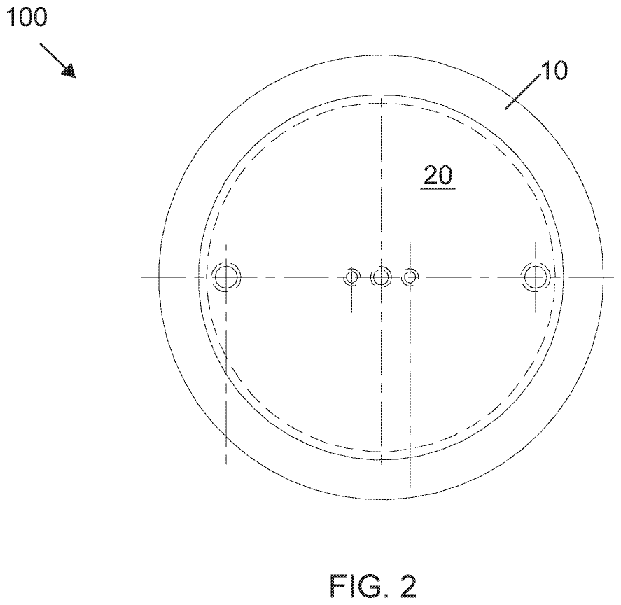

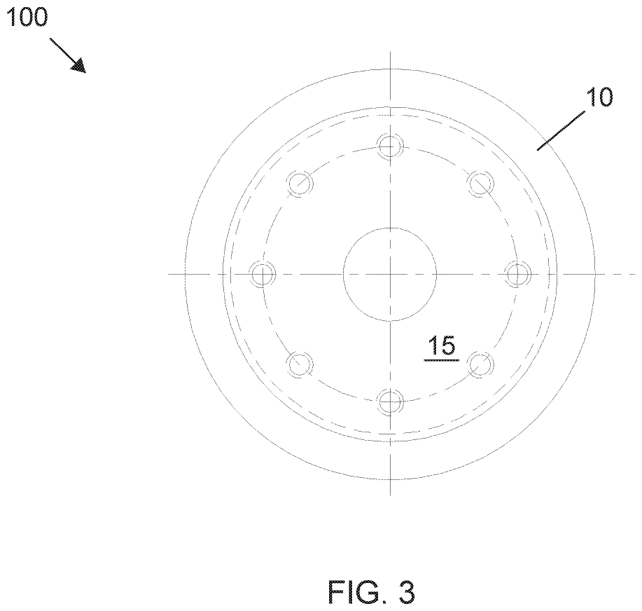

FIG. 2 is a top down view of the accumulator 100 depicted in FIG. 1. FIG. 2 depicts the gas head 20 and a portion of the housing 10. FIG. 3 is a bottom up view of the accumulator 100 depicted in FIG. 1. FIG. 3 depicts the fluid head 15 and a portion of the housing 10.

The accumulator housing 10 defines a chamber that is substantially centrally positioned within the cylinder geometry of the housing. A first edge (also referred to as end) of the chamber at the fluid end of the accumulator housing 10 is provided by a fluid head 15; and a second opposing edge (also referred to as end) of chamber at the gas end of the accumulator housing 10 is provided by the gas head 20. Each of the fluid head 15 and the gas head 20 may be composed of a metal, such as steel or aluminum. In one example, each of the fluid head 15 and the gas head 20 may be composed of carbon steel. Each of the fluid head 15 and the gas head 20 may be engaged to the accumulator housing 10 using mechanical fasteners, direct threaded engagement of the structures, adhesive engagement and combinations therefore. The fluid head 15 can include a fluid passage 14 therein to allow for the ingress and egress of fluid there through and from a fluid chamber 16. The fluid may provide the hydraulic actuation of the accumulator 100, and may be water based, oil based or a combination thereof. The gas head 20 can include a gas passage 19 therein to allow for the ingress and egress of gas there through to a gas chamber 21. When discussing the chamber of the accumulator housing 10 (or when referring to the chamber of the accumulator 100), the chamber includes both the fluid chamber 16 and the gas chamber 21.

Appropriate seals 2 can be utilized between the housing 10 and each of the fluid and gas heads 15, 20. The seals 2 may have an O-ring type geometry. The seals 2 may be set in a recess that is machined into each of the fluid and gas heads 15, 20. The seals 2 may be composed of a rubber type material and provide a sealing engagement by being in direct contact with the fluid and gas heads 15, 20 and the inner sidewall of the housing 10, i.e., simultaneously. The seals 2 may be composed of nitrile rubber, also known as NBR, Buna-N, and acrylonitrile butadiene rubber, which is a synthetic rubber copolymer of acrylonitrile (ACN) and butadiene.

In some embodiments, a piston 50 is disposed within the chamber 16, 21 and is movable relative to the fluid head 15 and the gas head 20. The hydraulic accumulator 100 uses the piston 50 (also referred to as a float) to keep the gas, e.g., nitrogen gas, from the gas chamber 21 separated from the hydraulic fluid, e.g., water and/or oil, from the fluid chamber 16. The piston 50 provides a sealed interface between the gas chamber 21 and the fluid chamber 16. For example, at least one piston seal 3a, 3b may be present on a sidewall of the piston 50 in direct contact with the inner sidewall of the housing 10. The at least one piston seal 3a, 3b may have an O-ring geometry, and may be composed of nitrile rubber, also known as NBR, Buna-N, and acrylonitrile butadiene rubber, which is a synthetic rubber copolymer of acrylonitrile (ACN) and butadiene. In some embodiments, a gas region side seal 3a is present at a gas side of the piston 50, e.g., at the end of the piston skirt, and a fluid region side seal 3b is present at a fluid side of the piston 50, e.g., at the piston deck side of the piston 50.

Referring to FIG. 1, the gas, e.g., nitrogen gas, within the gas chamber 21 is compressed with added fluid to the fluid chamber 16 at the opposing side of the piston 50 during the “charging” of the accumulator 100. Once the gas pressure, e.g., nitrogen gas pressure, is compressed to match the system pressure, the fluid within the fluid chamber 16, e.g., under the piston 50, is ready for delivery to a hydraulic cylinder (external from the accumulator 100). In some embodiments, the maximum allowable working pressure for the accumulator 100 having the aforementioned dimensions may range from 2,750 pounds per square inch gauge (psig) to 3,250 pounds per square inch gauge (psig). In one example, the maximum allowable working pressure for the accumulator 100 having the aforementioned dimensions is equal to 3,000 pounds per square inch gauge (psig). The hydrostatic test pressure is approximately 1.5× the maximum allowable working pressure. For example, when the maximum allowable working pressure is equal to 3,000 psi, the hydrostatic test pressure may be equal to 4,500 psi.

With the shift of a directional valve, the fluid from the fluid chamber 16, e.g., water and/or oil (hydraulic oil), is pushed towards the hydraulic cylinder, e.g., through the fluid passage 14, which causes the hydraulic cylinder to move quickly. In some embodiments, the oil is pushed toward the hydraulic cylinder at a rate ranging from approximately 750 gal/min to approximately 1,250 gal/min, In one example, the oil is pushed toward the hydraulic cylinder at a rate ranging from approximately 1000 gal/min.

During this release of the fluid from the fluid chamber 16, e.g., water and/or oil (hydraulic oil), the piston 50 travels T1 within the chamber 16, 21 of the accumulator 100. For example, in an accumulator 100 having the above described dimensions for the accumulator housing 10, the dimension of travel T1 may be approximately 12 inches, in which the piston sidewall length (also referred to as float length) is approximately 6 inches. The piston sidewall length may also be referred to as the length of the piston skirt. As noted above, the piston 50 includes at least one piston seal 3a, 3b present on the sidewall of the piston 50 in direct contact with the inner sidewall of the housing 10. The piston seals 3a, 3b wipe the interior sidewalk of the chamber 16, 21 (also referred to as barrel) while the piston is being traversed. T1 within the chamber 16, 21 to wipe the oil from the interior sidewalks of the chamber 16, 21. However, in operation, the piston 50 is traversed for durations ranging from the hundreds to the thousands of cycles a day in the function of the accumulator 100. Therefore, the piston seals 3a, 3b wear during the operation of the accumulator 100. As the piston seals 3a, 3b wear, the fluid from the fluid chamber 16, i.e., water and/or oil (hydraulic oil), is left of the interior sidewalls of the chamber 16, 21 (barrel) that the piston 50 overlaps during its traversal T1 within the chamber 16, 21. Eventually, this film of fluid, e.g., water and/or oil (hydraulic oil), falls into the piston 50, i.e., within the space defined by the piston skirt extending from the bottom of the piston deck. This fluid carry over ends up on the gas side of the piston 50, and compresses the gas, e.g., nitrogen gas, in the gas chamber 21 of the accumulator 100, but the fluid carry over is not useful to the system. As this carry over fluid accumulates, the operation of the diffuser system is compromised. Operational downtime is needed to drain the accumulated fluid from the piston 50 on the gas chamber 21 side of the accumulator 100. This downtime reduces efficiency and production in manufacturing applications employing the accumulator 100.

Referring to FIGS. 1 and 4-6, to reduce the incidence of fluid carry over, the methods and systems of the present disclosure increase the dimension of the piston sidewall. By increasing the length of the piston sidewall, the travel T1 that is required by the piston 50 to displace the fluid from the fluid chamber 16 is reduced. Reducing the travel T1 of the piston 50 reduces the stroke (also referred to as travel) that is applied to the piston seals 3a, 3b. By reducing the stroke (also referred to as travel) to the piston seals 3a, 3b, the wear forces applied to the piston seals 3a, 3b is also reduced, which increases the integrity and useable service life of the piston seals 3a, 3b. By increasing the integrity and useable service life of the piston seals 3a, 3b, the methods and structures of the present disclosure substantially decreases, if not eliminate, the incidence of fluid carry over.

In one embodiment, the methods and structures of hydraulic actuation employing the “extended float” type piston 50, i.e., piston 50 with a lengthened sidewall (also referred to as lengthened skirt), may include positioning the piston 50 within the chamber 16, 21 of a cylinder body (accumulator housing 10), the cylinder body having a chamber 16, 21 including a gas region 21 and a fluidized region 16. The sidewall of the piston 50 includes at least one sealing surface 3a, 3b for engaging the sidewall of chamber 16, 21. The method further includes traversing the piston 50 between a portion of the gas region 21 and a portion of the fluidized region 16. To reduce wear to the sealing surfaces, the distance of travel T1 of the piston 50 within the chamber that traverses the piston 50 between the gas region 21 and the fluidized region 16 is configured to be less than a length of the sidewall of the piston 50.

Referring to FIGS. 1 and 4-6, the sidewall S1 of the piston 50 may also be referred to as the piston skirt S1, and has a length L2 that is at least equal to a width W2 of a deck surface D1 of the piston 50. As noted previously, in prior piston 50 designs, the length L2 of the piston 50 is on the order of 6″, while the dimension of travel was approximately 12″. In this example, the length of the piston 50 is substantially half the length of the travel, which subjects the seals to substantial sliding force during the larger travel distance, In one example, length L2 of the sidewall S1 (piston skirt) of the piston 50 design of the present disclosure is substantially double the aforementioned prior piston design, and is substantially equal to the travel distance T1, i.e., the travel distance and the length L2 of the sidewall S1 (piston skirt) of the piston 50 are in an approximate 1:1 ratio. In some embodiments of the present disclosure, the length L2 of the sidewall S1 of the piston 50 is dimensioned so that a distance of travel T1 within the chamber 16, 21 that traverses the piston 50 between the gas region 16 and the fluidized region 21 is less than the length L2 of the sidewall S1 of the piston 50. It is noted that the aforementioned examples including the comparison of the length L2 of the sidewall (piston skirt) S1 in comparison to the distance of travel T1 in the accumulator 100 are provided for illustrative purposes only, and it is not intended that the present disclosure to limited to only these examples, as other dimensions have also been contemplated so long as they reduce the incident of fluid carry over. In some examples, the length L2 of the piston sidewall (piston skirt) is dimensioned to be a multiple of the operational travel distance T1 of the piston 50, in which the length L2 of the piston sidewall S1 is 0.8× (x=multiplication function(times)) the travel distance T1, the length L2 of the piston sidewall S1 is 0.9× the travel distance T1, the length L2 of the piston sidewall S1 is 1.0× the travel distance T1, the length L2 of the piston sidewall S1 is 1.25× the travel distance T1, the length L2 of the piston sidewall S1 is 1.5× the travel distance T1, the length L2 of the piston sidewall S1 is 1.75× the travel distance T1, or the length L2 of the piston sidewall S1 is 2.0× the travel distance T1. It is noted that the any range of the aforementioned values can be used to describe the dimensional relationship between the piston sidewall S1 and the piston travel distance T1, in which one of the aforementioned values provides a minimum to the range, and one of the aforementioned values provides a maximum to the range.

Still referring to FIGS. 1 and 4-6, the at least one piston seal 3a, 3b may include a gas region side seal 3a that is present at a gas side (gas chamber 21 side) of the piston 50, and a fluid region side seal 3b that is present at a fluid side (fluid chamber 16 side) of the piston 50. The fluid region side seal 3b is present at a deck surface D1 side of the piston 50.

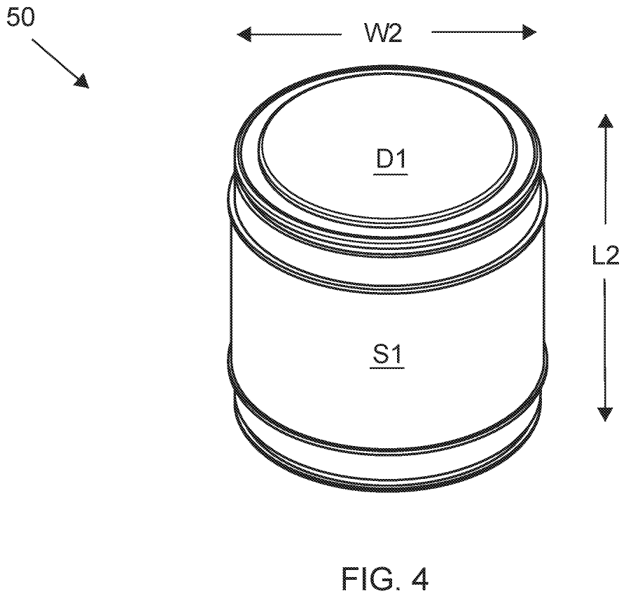

The piston 50 is now described in greater detail with reference to FIGS. 4-6. The piston 50 may include a deck surface D1 that provides an interface between the gas region, i.e., gas chamber 21, and the fluidized region, i.e., fluid chamber 16. of an accumulator body, i.e., the housing 10 for the accumulator 100. The piston 50 includes a skirt sidewall S1 (also referred to as piston skirt or piston sidewall) that extends from the deck surface D1, in which the skirt sidewall S1 includes at least one sealing surface 3a, 3b for engaging a sidewall of a chamber including the gas region 21 and the fluidized region 16 for the accumulator 100.

The skirt sidewall S1 of the piston 50 has a length L2 that is at least equal to the width W2 of the deck surface D1. In prior accumulator designs having the aforementioned dimensions for the accumulator housing 10, the width W2 of the deck surface D1 was equal to approximately 12″. As noted above, in prior accumulator designs having the dimensions for the accumulator housing 10 described above with reference to FIG. 1, the piston has a sidewall length of 6″. The width of the piston employed in these prior accumulator designs was approximately 12″. Therefore, in this example of a prior accumulator the length of the piston sidewall is approximately half the width of the deck surface. As noted throughout, in the piston 50 designs of the present disclosure, to reduce the incidence of fluid carry over, the piston sidewall S1 (also referred to as piston skirt) is increased in length L2, to a dimension of 12″. In the example, in which the housing 10 of the accumulator has the dimensions described with reference to FIG. 1, increasing the length L2 of the sidewall S1 of piston (piston skirt) to be substantially the same as the travel distance, to be substantially the same as the width W1 of the deck surface D1. More specifically, in one example, the width W1 of the deck surface D1 of the piston can be equal to substantially 12″ and the length of the piston skirt S1 can be equal to substantially 12″. It is noted that the aforementioned examples including the comparison of the length L2 of the sidewall (piston skirt) S1 in comparison to the width W2 of deck surface D1 of the piston 50 are provided for illustrative purposes only, and it is not intended that the present disclosure to limited to only these examples, as other dimensions have also been contemplated. In some examples, the length L2 of the piston sidewall (piston skirt) has dimensions that are a multiple of the width W2 of the deck surface S1 of the piston 50, in which the length L2 of the piston sidewall Si is 0.8× (x=multiplication function(times)) the width W2 of the deck surface D1, the length L2 of the piston sidewall S1 is 0.9× the width W2 of the deck surface D1, the length L2 of the piston sidewall S1 is 1.0× the width W1 of the deck surface D1, the length L2 of the piston sidewall S1 is 1.25× the width W2 of the deck surface D1, the length L2 of the piston sidewall S1 is 1.5× the width W1 of the deck surface D1, the length L2 of the piston sidewall S1 is 1.75× the width W2 of the deck surface D1, or the length L2 of the piston sidewall S1 is 2.0× the width W2 of the deck surface D1. It is noted that the any range of the aforementioned values can be used to describe the dimensional relationship between the piston sidewall S1 and the width W2 of the deck surface D1, in which one of the aforementioned values provides a minimum to the range, and one of the aforementioned values provides a maximum to the range.

Referring to FIGS. 4-6, the piston 50 includes the at least one sealing surface 3a, 3b on the sidewall S1 of the piston 50 that includes a recess 4 for engaging a seal, a raised ridge 5 on a first side of the recess 4 for retaining the seal within the recess 4, and a slot 6 on a second side of the recess 4 for engagement by a snap ring. The seal is retained within the recess 4 between the snap ring and the raised ridge 5. In one embodiment, the at least one sealing surface 3a, 3b includes a gas region side seal 3a that is present at a skirt side of the piston 50, and a fluid region side seal 3b present at a deck surface D1 side of the piston 50.

The deck surface D1 of the piston 50 can planar or the deck surface D1 of the piston 50 can includes a dome, or a dish. The deck surface D1 can be modified to provide additional volume or less volume of fluid to be moved by the piston 50 while the piston is moved along the travel distance T1.

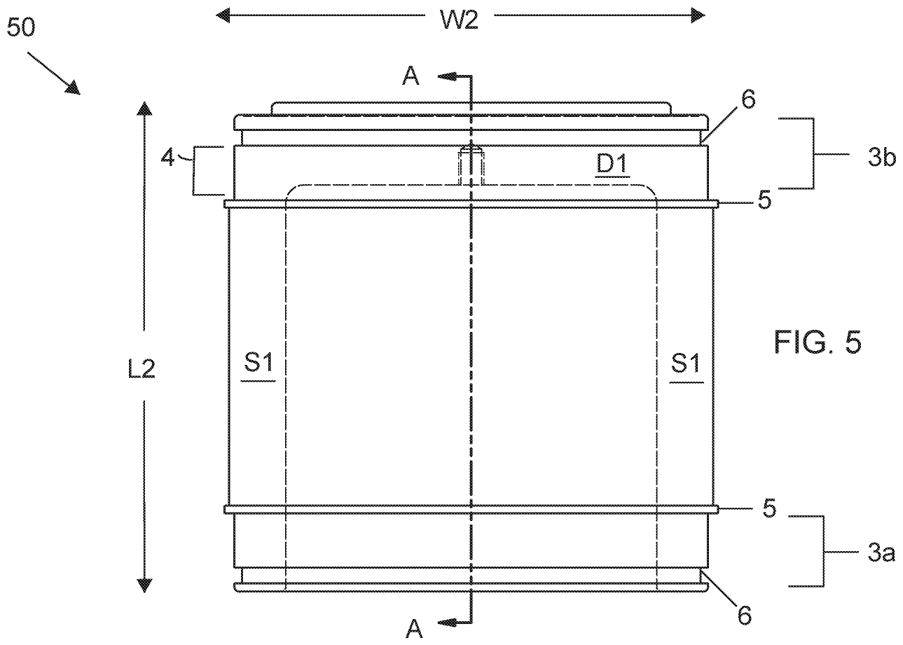

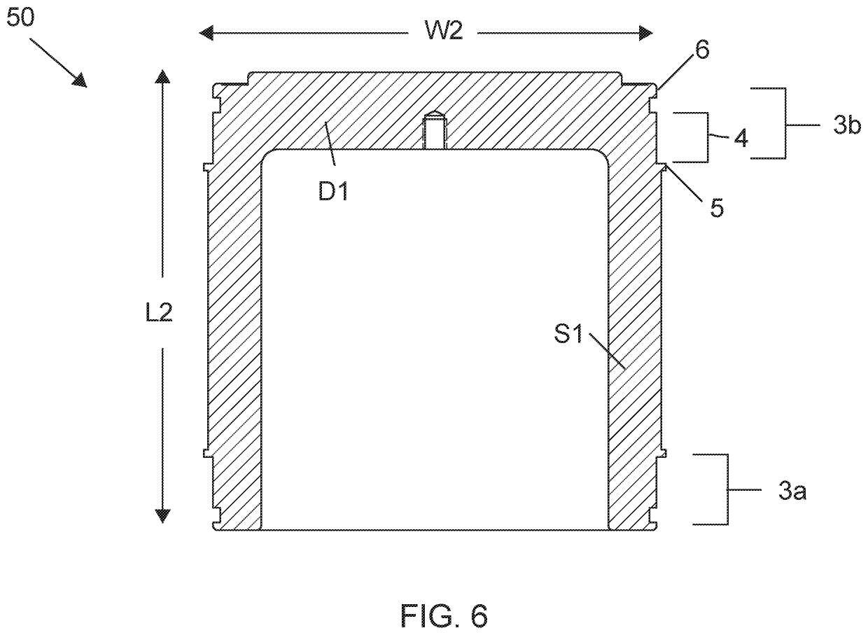

Referring to FIGS. 5 and 6, the piston 50 when viewed from a side cross-sectional view has a U-shaped geometry. The piston 50 can be composed of a metal, such as steel or aluminum. In one example, the piston 50 is composed of a precipitation-hardened aluminum alloy, containing magnesium and silicon as its major alloying elements that is treated with a T6 heat treatment, such as AA 6061-T6.

The piston 50 depicted in FIGS. 4-6 can be positioned within a chamber 16, 21 including a gas region and a fluidized region of an accumulator 100, wherein by increasing the length L2 of the skirt sidewall S1 to be greater than or equal to the width W2 of the deck surface D1, the travel distance T1 of the piston 50 within the chamber between the fluidized region and the gas region is reduced. The travel distance T1 for the piston 50 is less than the length L2 of the skirt sidewall S1. By increasing the sidewall length S1 for the piston 50 so that the travel distance T1 for the piston 50 is less than the length L2 of the skirt sidewall S1, the piston 50 and accumulator 100 designs provided herein reduce wear on the at least one sealing surface 3a, 3b, and reduce, if not eliminate, the incidence of fluid carry over.

Referring to FIG. 1, in some embodiments, although the accumulator designs 100 described herein can eliminate fluid carry over, the accumulator designs 100 can include a system including a drain hose 11 and valve assembly 12 for removing any fluid from the piston skirt end of the piston 50.

The accumulator 100 depicted in FIGS. 1-3 can have an approximate dry weight of 2,000 lbs. and an approximate fill weight of 2,415 lbs. The temperature rating of the accumulator 100 may range from −20° F. to 200° F.

An exemplary method of hydraulic actuation comprises: positioning a piston within the chamber of a cylinder body, the chamber including a gas region and a fluidized region, the sidewall of the piston including at least one sealing surface for engaging the sidewall of chamber; and traversing the piston between a portion of the gas region and a portion of the fluidized region, wherein a distance of travel within the chamber that the piston traverses between the gas region and the fluidized region is less than a length of the sidewall of the piston.

An exemplary accumulator comprises: a cylinder body having a chamber including a gas region and a fluidized region; and a piston present within the chamber of the cylinder body, the piston including a deck surface facing the gas region of the chamber, and a skirt end of the piston facing the fluidized region of the chamber, and a sidewall of the piston including at least one sealing surface for engaging the sidewall of chamber, the length of the sidewall of the piston is dimensioned so that a distance of travel within the chamber that the piston traverses between the gas region and the fluidized region is less than the length of the sidewall of the piston.

In an exemplary accumulator embodiment, the sidewall of the piston has a length that is at least equal to a width of a deck surface of the piston.

In an exemplary accumulator embodiment, the at least one sealing surface of the sidewall of the piston includes a recess for engaging a seal in direct contact with the sidewall of the piston and the sidewall of the chamber.

In an exemplary accumulator embodiment, a gas region side seal is present at a gas side of the piston, and a fluid region side seal is present at a fluid side of the piston.

In an exemplary accumulator embodiment, the deck surface of the piston faces the fluidized region.

In an exemplary accumulator embodiment, the length of the sidewall of the piston is 12 inches.

An exemplary piston comprises: a deck surface that provides an interface between the gas region and a fluidized region of an accumulator body; and a skirt sidewall that extends from the deck surface, the skirt sidewall includes at least one sealing surface for engaging a sidewall of a chamber including the gas region and the fluidized region for the accumulator, wherein the skirt sidewall has a length that is at least equal to the width of the deck surface.

In an exemplary piston embodiment, the at least one sealing surface on the sidewall of the piston includes a recess for engaging a seal, a raised ridge on a first side of the recess for retaining the seal within the recess, and a slot on a second side of the recess for engagement by a snap ring, the seal retained within the recess between the snap ring and the raised ridge.

In an exemplary piston embodiment, the at least one sealing surface comprises a gas region side seal present at a deck surface side of the piston, and a fluid region side seal present skirt side of the piston.

In an exemplary piston embodiment, the deck surface of the piston is planar, the deck surface of the piston includes a dome, or the deck surface includes a dish.

In an exemplary piston embodiment, a side cross-section of the piston has a U-shaped geometry.

In an exemplary piston embodiment, the piston is positioned within a chamber of an accumulator including a gas region and a fluidized region, wherein by increasing the length of the skirt sidewall to be greater than or equal to the width of the deck surface, the travel distance of the piston within the chamber between the fluidized region and the gas region is reduced. In such an exemplary piston embodiment, the travel distance for the piston can be less than the length of the skirt sidewall. In still other such exemplary piston embodiments, the travel distance for the piston can be less than the length of the skirt sidewall reduces wear on the at least one sealing surface.

It will also be understood that when an element is referred to as being “on” or “over” another element, it can be directly on the other element or intervening elements can also be present. In contrast, when an element is referred to as being “directly on” or “directly over” another element, there are no intervening elements present. It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as readily apparent by one of ordinary skill in this and related arts, for as many items listed.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Spatially relative terms, such as “beneath,” “below,” “lower,” “above,” “upper,” and the like, can be used herein for ease of description to describe one element's or feature's relationship to another element(s) or feature(s) as illustrated in the FIGS. It will be understood that the spatially relative terms are intended to encompass different orientations of the device in use or operation in addition to the orientation depicted in the FIGS. For example, if the device in the FIGS. is turned over, elements described as “below” or “beneath” other elements or features would then be oriented “above” the other elements or features. Thus, the term “below” can encompass both an orientation of above and below. The device can be otherwise oriented (rotated 90 degrees or at other orientations), and the spatially relative descriptors used herein can be interpreted accordingly. In addition, it will also be understood that when a layer is referred to as being “between” two layers, it can be the only layer between the two layers, or one or more intervening layers can also be present.

It will be understood that, although the terms first, second, etc. can be used herein to describe various elements, these elements should not be limited by these terms. These terms are only used to distinguish one element from another element. Thus, a first element discussed below could be termed a second element without departing from the scope of the present concept.

Having described preferred embodiments of a method, structures and systems for providing accumulators that reduce the incidence of fluid carry over, it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method of hydraulic actuation comprising:
positioning a piston within the chamber of a cylinder body, the chamber including a gas region and a fluidized region, the sidewall of the piston including at least one sealing surface for engaging the sidewall of chamber; and
traversing the piston between a portion of the gas region and a portion of the fluidized region, wherein a distance of travel within the chamber that the piston traverses between the gas region and the fluidized region is less than a length of the sidewall of the piston.

2. The method of claim 1, wherein the sidewall of the piston has a length that is at least equal to a width of a deck surface of the piston.

3. The method of claim 1, wherein the at least one sealing surface of the sidewall of the piston includes a recess for engaging a seal in direct contact with the sidewall of the piston and the sidewall of the chamber.

4. The method of claim 1, wherein a gas region side seal is present at a gas side of the piston, and a fluid region side seal is present at a fluid side of the piston.

5. The method of claim 2, wherein the deck surface of the piston faces the fluidized region.

6. The method of claim 1, wherein the length of the sidewall of the piston is 12 inches.

7. An accumulator comprising:
a cylinder body having a chamber including a gas region and a fluidized region; and
a piston present within the chamber of the cylinder body, the piston including a deck surface facing the gas region of the chamber, and a skirt end of the piston facing the fluidized region of the chamber, and a sidewall of the piston including at least one sealing surface for engaging the sidewall of chamber, the length of the sidewall of the piston is dimensioned so that a distance of travel within the chamber that the piston traverses between the gas region and the fluidized region is less than the length of the sidewall of the piston.

8. The accumulator of claim 7, wherein the sidewall of the piston has a length that is at least equal to a width of a deck surface of the piston.

9. The accumulator of claim 7, wherein the at least one sealing surface of the sidewall of the piston includes a recess for engaging a seal in direct contact with the sidewall of the piston and the sidewall of the chamber.

10. The accumulator of claim 7, wherein a gas region side seal is present at a gas side of the piston, and a fluid region side seal is present at a fluid side of the piston.

11. The accumulator of claim 7, wherein the deck surface of the piston faces the fluidized region.

12. The accumulator of claim 7, wherein the length of the sidewall of the piston is 12 inches.

13. A piston comprising:
a deck surface providing an interface between the gas region and a fluidized region of an accumulator body; and
a skirt sidewall extending from the deck surface, the skirt sidewall includes at least one sealing surface for engaging a sidewall of a chamber including the gas region and the fluidized region for the accumulator, wherein the skirt sidewall has a length that is at least equal to the width of the deck surface.

14. The piston of claim 13, wherein the at least one sealing surface on the sidewall of the piston includes a recess for engaging a seal, a raised ridge on a first side of the recess for retaining the seal within the recess, and a slot on a second side of the recess for engagement by a snap ring, the seal retained within the recess between the snap ring and the raised ridge.

15. The piston of claim 13, wherein the at least one sealing surface comprises a gas region side seal that is present at a deck surface side of the piston, and a fluid region side seal that is present skirt side of the piston.

16. The piston of claim 13, wherein the deck surface of the piston is planar, the deck surface of the piston includes a dome, or the deck surface includes a dish.

17. The piston of claim 13, wherein a side cross-section of the piston has a U-shaped geometry.

18. The piston of claim 13, wherein the piston is positioned within a chamber of an accumulator including a gas region and a fluidized region, wherein by increasing the length of the skirt sidewall to be greater than or equal to the width of the deck surface, the travel distance of the piston within the chamber between the fluidized region and the gas region is reduced.

19. The piston of claim 18, wherein the travel distance for the piston is less than the length of the skirt sidewall.

20. The piston of claim 19, wherein the travel distance for the piston that is less than the length of the skirt sidewall reduces wear on the at least one sealing surface.
